(19) United States
(12) Patent Application Publication
(10) Pub. No.: US 2022/0352796 A1
(43) Pub. Date: Nov. 3, 2022

(54) METHOD OF MANUFACTURING STATOR

(71) Applicants: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(72) Inventors: Mashahiro UCHIYAMA, Yokohama Kanagawa (JP); Takahiro TOI, Yokohama Kanagawa (JP); Kentaro MIYAZAKI, Yokohama Kanagawa (JP); Kenta FUKATSU, Fujisawa Kanagawa (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(21) Appl. No.: 17/865,232

(22) Filed: Jul. 14, 2022

Related U.S. Application Data
(63) Continuation of application No. PCT/JP2020/001132, filed on Jan. 15, 2020.

(51) Int. Cl. H02K 15/06; H02K 15/00

(52) U.S. Cl. CPC H02K 15/066; H02K 15/0081

(57) ABSTRACT

According to one embodiment, in a method, while supporting as end of an extension part of a coil segment by a flange of a forming jig from the radially outside and pressing an inclined, surface toward the other end surface in an axial direction of the stator core by a pressing part of the forming jig, rotating the stator core in a circumferential direction relative to the forming jig, in order to bend the extension part in the circumferential direction of the stator core such that the inclined surface is positioned to be substantially parallel to the other end surface. Thereafter, joining the inclined surfaces adjacent to each other is the radial direction of the stator core.

### CROSS-REFERENCE TO RELATED APPLICATIONS

This application is a Continuation Application of PCT Application No. PCT/JP2020/001132, filed Jan. 15, 2020, the entire contents of which are incorporated herein by reference.

### FIELD

Embodiments described herein relate generally to a method of manufacturing a stator.

### BACKGROUND

Rotary electric machines comprise a cylindrical stator, and a rotor rotatably provided with the stator. The stator includes a stator core including a large number of cylindrical electromagnetic steel plates, and a coil attached to the stator core. The coil formed by joining a plurality of coil segments together includes coil ends projecting in the axial direction from the both end surfaces of the stator core. In recent, years, there is a demand for a much smaller stator of the rotary electric machine.

### BRIEF DESCRIPTION OF THE DRAWINGS

FIG. 1 is a longitudinal sectional view illustrating a rotary electric machine of an embodiment.

FIG. 2 is a cross-sectional view illustrating the rotary electric machine.

FIG. 3 is a perspective view illustrating the other end surface side of a stator of the rotary electric machine.

FIG. 4 is a perspective view illustrating a coil end part of a coil segment of the stator in an area A of FIG. 3, in an enlarged manner.

FIG. 5 is a perspective view illustrating the coil segment.

FIG. 6 is a perspective view illustrating a stator core and the coil segments arranged in a cylindrical shape.

FIG. 7 is a perspective view illustrating a state where the coil segments are attached to the stator core.

FIG. 8 is a perspective view illustrating the other end surface side of the stator core and extension parts of the coil segments.

FIG. 9 is a perspective view of an area B of FIG. 8 in an enlarged manner.

FIG. 10 is a perspective view illustrating a state where an inner wall jig is attached to the inside of the stator core.

FIG. 11 is a perspective view illustrating a forming jig which forms the coil segments by bending.

FIG. 12 is a perspective view illustrating a state where 48 coil segments positioned in the sixth layer (outermost layer) out of the coil segments attached to the stator core are formed by bending initially (for the first time) by 48 forming jigs.

FIG. 13 is a perspective view illustrating one coil segment before bending in an area D of FIG. 12.

FIG. 14 is a perspective view illustrating one coil segment after bending in the area D of FIG. 12.

FIG. 15 is a schematic side view illustrating a process of bending of the coil segments.

FIG. 16 is a perspective view illustrating a state where 48 coil segments positioned in the first layer (innermost layer) out of the coil segments attached to the stator core are formed by bending lastly (for the sixth time) by 48 forming jigs.

FIG. 17 is a perspective view illustrating one coil segment before bending in an area E of FIG. 16.

FIG. 18 is a perspective view illustrating one coil segment after bending in the area E of FIG. 16.

FIG. 19 is a perspective view illustrating an inclined surface of the coil segment formed by bending in an enlarged manner.

FIG. 20 is a perspective view illustrating a bending treatment process of the coil segments by the inner wall jig and an outer wall jig.

FIG. 21 is a perspective view illustrating a part of the inner wall jig, outer wall jig, and extension part of the coil segment in the bending treatment, in an enlarged manner.

FIG. 22 is a perspective view illustrating extension parts bent.

FIG. 23 is a perspective view illustrating a welding process of the coil segment.

FIG. 24 is a perspective view illustrating inclined surfaces of the welded coil segments, in an enlarged manner.

### DETAILED DESCRIPTION

Various embodiments will be described hereinafter with reference to the accompanying drawings. In general, according to one embodiment, a method of manufacturing a stator comprises preparing a plurality of coil segments which are rectangular conductors each including a pair of linear parts having an inclined surface inclined with respect to a length direction as each end thereof and other ends of the pair of linear part are connected to each other.

The pair of linear parts of each of the coil segments are inserted from one end surface side of a stator core into each of slots such that an extension part formed of the linear part and the inclined surface projects from the other end surface side of the stator core, and multiple linear parts in each slot are placed to be adjacent to each other in a radial direction, in order to arrange the coil segments in a multilayered cylindrical shape coaxial with the stator core.

While supporting an end of the extension part by a flange of a first jig from the radially outside of the stator core and pressing the inclined surface toward the other end surface of the stator core in an axial direction of the stator core by a pressing part of the first jig, the stator core is rotated in a circumferential direction relative to the first jig, in order to bend the extension part in the circumferential direction of the stator core such that the inclined surface is positioned to be substantially parallel to the other end surface.

The inclined surfaces adjacent to each other in the radial direction of the stator core are joined to each other.

It should be noted that the disclosure is merely an example, and changes which are made appropriately while maintaining the gist of the invention and can be easily conceived by a person skilled in the art are naturally included in the scope of the present invention. Further, in order to clarify the explanation, the drawings may schematically represent the dimensions, shapes, etc., of each part as compared with the actual aspects, but they are merely examples and do not limit the interpretation of the present invention. Further, in the present specification and each figure, the same elements as those described above with reference to the figure already referred to may be designated by the same reference numerals, and detailed description thereof may be omitted as appropriate.

### EMBODIMENT

First, an example of a rotary electric machine to which a stator of the embodiment is applied will be described.

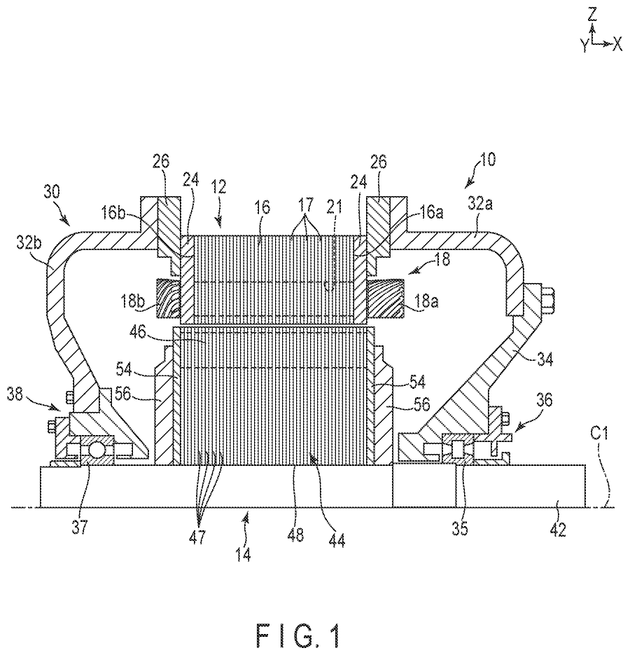

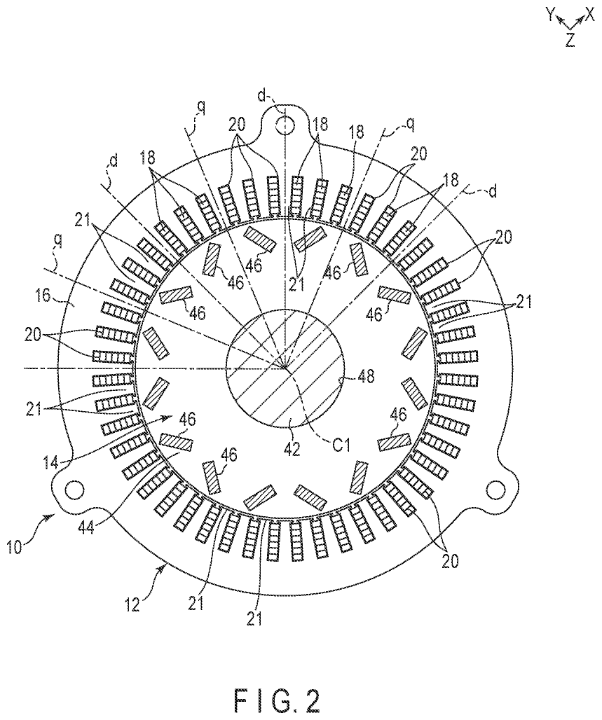

FIG. 1 is a longitudinal-sectional view of the rotary electric machine of the embodiment, showing only one half centered on a central axis C1. FIG. 2 is a cross-sectional view of the rotary electric machine.

As in FIG. 1, a rotary electric machine 10 is configured, for example, as a permanent magnet rotary electric machine. The rotary electric machine 10 comprises an annular or cylindrical stator 12, rotor 14 supported rotatable around the central axis C1 and coaxially with the stator 12 inside the stator 12, and a casing 30 supporting the stator 12 and the rotor 14.

In the following description, direction of extension of the central axis C1 is referred to as axial direction, direction of rotation around the central axis C1 as circumferential direction, and directions orthogonal to the axial and circumferential directions as radial direction.

As in FIGS. 1 and 2, the stator 12 comprises a cylindrical stator core 16, and rotor windings (coils) 18 wound around the stator core 16. The stator core 16 includes a large number of circularly shaped electromagnetic steel plates 17 of magnetic material, for example, silicon steel, laminated in a concentric manner. The large number of electromagnetic steel plates 17 are joined together in the laminated state by welding multiple locations on the outer peripheral surface of the stator core 16. The stator core 16 has one end surface 16a located at one end in the axial direction and other end surface 16b located at the other end in the axial direction. The one end surface 16a and the other end surface 16b extend orthogonally to the central axis C1.

A plurality of slots 20 are formed in the inner periphery of the stator core 16. The slots 20 are equally spaced in the circumferential direction. Each slot 20 is open to the inner circumference of the stator core 16 and extends radially from the inner circumference to the outer circumference in the radial direction. Each slot 20 extends over the entire axial length of the stator core 16. One end of each slot 20 is open to one end surface 16a and the other end is open to the other end surface 16b.

By forming the slots 20, the inner peripheral portion of the stator core 16 forms a plurality of teeth 21 projecting toward the central axis C1 (for example, 48 teeth in the present embodiment). The 21 teeth are equally spaced in the circumferential direction. Thus, stator core 16 integrally includes an annular yoke portion and the teeth 21 protruding radially from the inner circumference of the yoke portion toward the central axis line C1.

A coil 18 is embedded in the slots 20 and wound around each of the teeth 21. The coil 18 includes coil ends 18a and 18b extending from one end surface 16a of the stator core 16 and the other end surface 16 thereof toward the outer axis direction. By applying an alternating current to the coil 18, a predetermined chain flux is formed in the stator 12 (teeth 21).

As in FIG. 1, at both axial ends of stator core 16, there are core end plates 24 each having the same cross sectional shape as stator core 16. Furthermore, a core retainer 26 is disposed on the core end plates 24.

The casing 30 includes a substantially cylindrical first bracket 32a and a bowl-shaped second bracket 32b. The first bracket 32a is connected to the core retainer 26 located in the drive end side of the stator core 16. The second bracket 32b is connected to the core retainer 26 located in the anti-drive end side. The first and second brackets 32a, 32b are formed of, for example, aluminum alloy. An annular bearing bracket 34 is bolted coaxially to the tip end side of the first bracket 32a. For example, a first bearing 36 with a built-in roller bearing 35 is fastened to the center of the bearing bracket 34. A second bearing 38 with a built-in ball bearing 37 is fastened to the center of the second bracket 32b.

On the other hand, the rotor 14 includes a cylindrical shaft (rotary shaft) 42 supported rotatably about the central axis C1 by the first and second bearings 36 and 38, cylindrical rotor core 44 fixed in approximately the center of the shaft 42 in the axial direction, and a plurality of permanent magnets 46 embedded within the rotor core 44. The rotor core 44 is constructed as a laminate of a number of circularly shaped electromagnetic steel plates 47 of magnetic material, for example, silicon steel, laminated in a concentric manner. The rotor core 44 has an inner hole 48 formed coaxially with the central axis C1. The shaft 42 is inserted and fitted into the inner hole 48 and extends coaxially with the rotor core 44. An abbreviated disc-shaped magnetic shielding plate 54 and a rotor core retainer 56 are provided with both axial ends of the rotor core 44.

As shown in FIGS. 1 and 2, the rotor core 44 is coaxially arranged inside the stator core 16 with a small gap (air gap) therebetween. In other words, the outer circumferential surface of the rotor core 44 faces the inner circumferential surface of the stator core 16 (tip end surface of the teeth 21) with a small gap.

The rotor core 44 includes a plurality of magnet embedded holes penetrating in the axial direction. A permanent magnet 46 is loaded and positioned in each magnet hole and secured to the rotor core 44 by, for example, an adhesive agent. Each permanent magnet 46 extends over the entire length of the rotor core 44. The plurality of permanent magnets 46 are arranged at predetermined intervals in the circumferential direction of the rotor core 44.

As in FIG. 2, the rotor core 44 has a d-axis extending in the radial direction or radially of the rotor core 44, respectively, and a q-axis electrically spaced 90 degrees with respect to the d-axis. In this example, the axis extending radially through the boundary between adjacent poles and the central axis C1 is the q-axis, and the direction electrically perpendicular to the q-axis is the d-axis. The d-axis and q-axis are provided alternately in the circumferential direction of the rotor core 44 and in predetermined phases.

In the circumferential direction of the rotor core 44, two permanent magnets 46 are located on both sides of each d-axis. Each permanent magnet 46 is formed as an elongated flat plate with a rectangular cross section, and has a length approximately equal to the axial length of the rotor core 44. When viewed in the cross section perpendicular to the central axis C1 of the rotor core 44, the permanent magnets 46 are each oriented with respect to the d-axis. The two permanent magnets 46 are arranged side by side in an approximately V-shaped arrangement, for example. In this example, the inner peripheral ends of the permanent magnets 46 are each adjacent to the d-axis and face each other with a slight gap therebetween. The outer peripheral ends of the permanent magnets 46 are spaced apart from the d-axis along the circumferential direction of the rotor core 44, and located near the outer circumference of the rotor core 44 and near the q-axis. As a result, the outer peripheral ends of the permanent magnets 46 are adjacent and opposite to the outer circumferential end of the permanent magnets 46 of the adjacent poles across the q-axis.

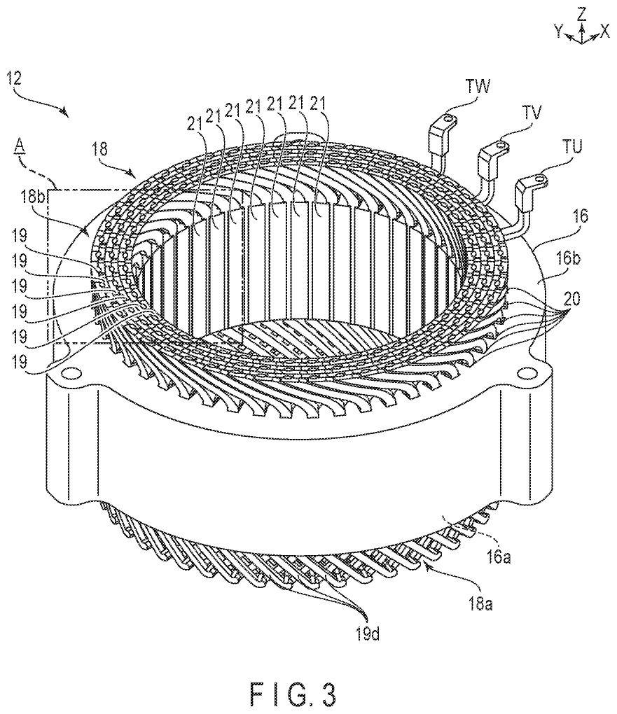

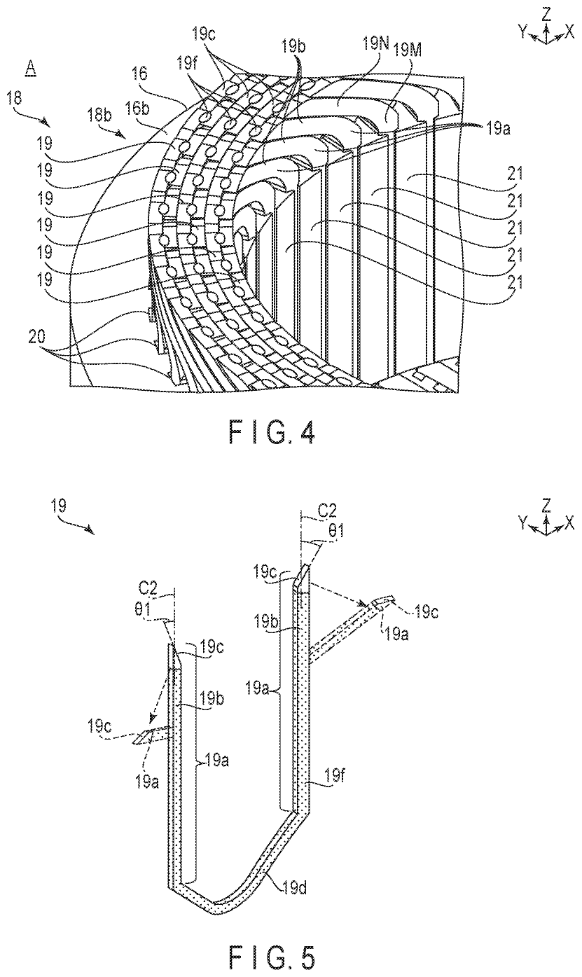

FIG. 3 is a perspective view illustrating the other end surface side of the stator, FIG. 4 is a perspective view illustrating an enlarged view of the second coil end part, of the stator in area A of FIG. 3, and FIG. 5 is a perspective view illustrating the coil segment. As in FIGS. 3 and 4, the coil 18 is structured as a flat conductor, including a plurality of coil segments 19 formed of copper flat wires with a rectangular cross-sectional shape that intersect the wire lengthwise, and assembled to the stator core 16.

As in FIG. 5, the coil segment 19 is formed into an approximately U-shape by cutting and bending a flat wire. In other words, the coil segment 19 integrally includes a pair of linear parts 19a, each end of which has an inclined surface 19c facing each other at a distance and inclined with respect to the longitudinal direction, and a bridge 19d connecting the other ends of linear parts 19a. The coil segment 19 has a rectangular cross-sectional shape, i.e., the cross-section has a pair of long sides opposed to each other and a pair of short sides opposed to each other. The outer surface of the coil segment 19 is covered with an insulating coating 19e, such as enamel (illustrated by dots). At the extension end of each linear part 19a, the insulating coating 19e has been removed and is ready to conduct. The extension part 19b of the pair of linear parts 19a includes, at the tip thereof, inclined surface 19a inclined at a predetermined angle (less than 90 degrees) with respect to the central axis along the length direction of 19a. The inclined surface 19c is shaped as rectangule, with a pair of long sides inclined at a predetermined angle with respect to the central axis line, and a pair of short sides extending in a direction orthogonal to the central axis line. The insulating film 19e, which is illustrated with dots in FIG. 5, is omitted in the figures other than FIG. 5.

As in FIG. 3, a plurality of coil segments 19 are arranged in a plurality of cylindrical shapes, in this example, six-layer cylindrical shapes, and a pair of linear parts 19a of each coil segment are inserted in different slots 20 corresponding to each other from, for example, one end surface 16a side of the stator core 16, and protrude from the other end surface 16b of stator core 16 by a predetermined length. As in FIG. 2, six linear parts 19a are inserted into one slot 20, for example. In the slot 20, the six linear parts 19a are arranged in the radial direction of the stator core 16. The six linear parts 19a are arranged, in the slot 20 with their long sides facing each other in parallel.

The bridging portion 19d of the coil segment 19 is opposed to one end surface 16a of the stator core 16 with a slight gap therebetween. The bridges 19d extend along the approximate circumferential direction of the stator core 16, with some bridges 19d intersecting and extending with the other bridges 19d. The bridges 19d structure the coil ends 18a protruding from the one end surface 16a.

As in FIGS. 3 and 4, the linear part 19a extending axially by a predetermined length from the other end surface 16b is bent along the circumference direction of the stator core 16, and extends inclining with respect to the axial direction. In detail, the extension part 19b of each linear part 19a includes a first bending part 19M bent in the circumferential direction from the axial direction of the stator core 16 and an inclined part 19N linearly extending from the first bending part 19M while being inclined with resect to the axial direction. The inclined surface 19c located at the tip of the stator core 19b is approximately parallel to the other end surface 16b of the stator core 16.

The extension parts 19b of the six linear parts 19a inserted in each slot 20 are alternately bent in one direction and in the opposite direction. That is, the innermost extension part 19b is bent in one direction in the circumference direction of the stator core 16, and one outer extension part 19b is bent in the other direction (reverse direction) in the circumferential direction. One more outer extension part 19b is bent in one direction. The six extension parts 19b extending from different slots 20 are bent such that the inclined surfaces 19c are positioned approximately in a row in the axial direction of the stator core 16. The six inclined surfaces 19c extend in approximately the same plane.

The tip or inclined surfaces 19c of the six linear part 19a in each row radially aligned are mechanically and electrically bonded two by two to each other. For joining, for example, laser welding can be used. A laser beam is irradiated onto the two inclined surfaces 19c, partially melting the conductors to produce a weld bead 19f. By welding two adjacent tips in the radial direction together, the entire multiple coil segments form a three-phase coil 18. Furthermore, the extension part 19b forms the coil end 18b protruding from the other end surface 16b. The tip (conductive part) including the inclined surface (welding surface) of the linear part 19a is covered with an insulating material which is not shown, such as powder coating, or varnish.

As in FIG. 3, to three of the coils 18, U-phase connection terminal TU, V-phase connection terminal TV, and W-phase connection terminal TW are connected, respectively.

Next, an example of a manufacturing method of the stator of the rotary electric machine of the embodiment will be described.

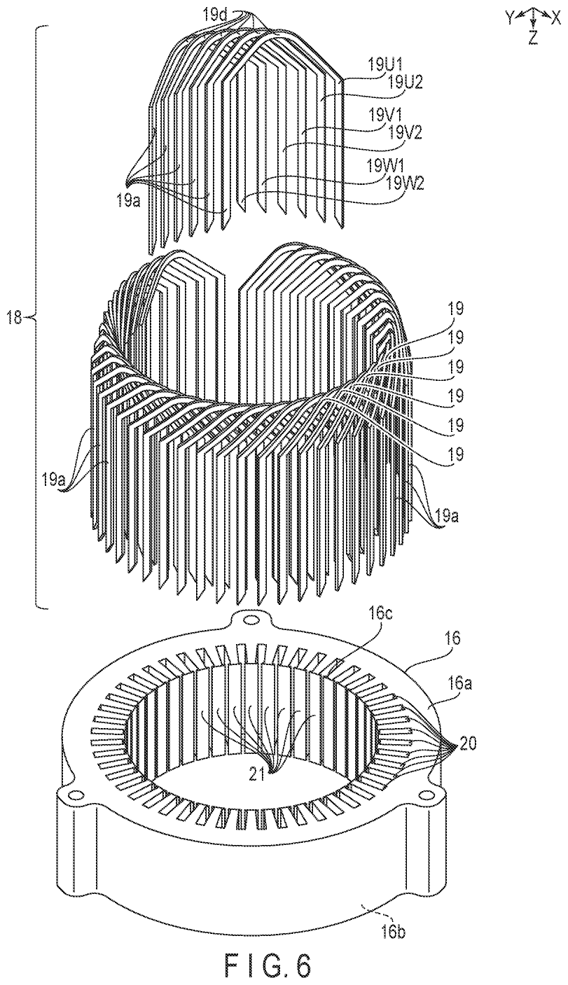

FIG. 6 is a perspective view illustrating the stator core 16 and the coil segments 19 arranged in a cylindrical shape.

As in FIG. 6, a large number of coil segments 19 are first prepared, and arranged in a cylindrical shape. Although this is not shown, three sets of coil segments 19 each arranged in a cylindrical shape are prepared. One set (48) coil segments 19 are arranged cylindrically along a plurality of slots 20 in the stator core 16. One set of coil segments 19 includes eight units with six coil segments of; two coil segments 19U1 and 19U2 for U phase, two coil segments 19V1 and 19V2 for V phase, and two coil segments 19W1 and 19W2 for W phase as a minimum unit. In one cylindrically arranged set, linear parts 19a of the coil segment 19 are arranged in two rows in the radial direction. That is, many (48×2) linear parts 19a are arranged in a cylindrical shape with two layers of different diameters.

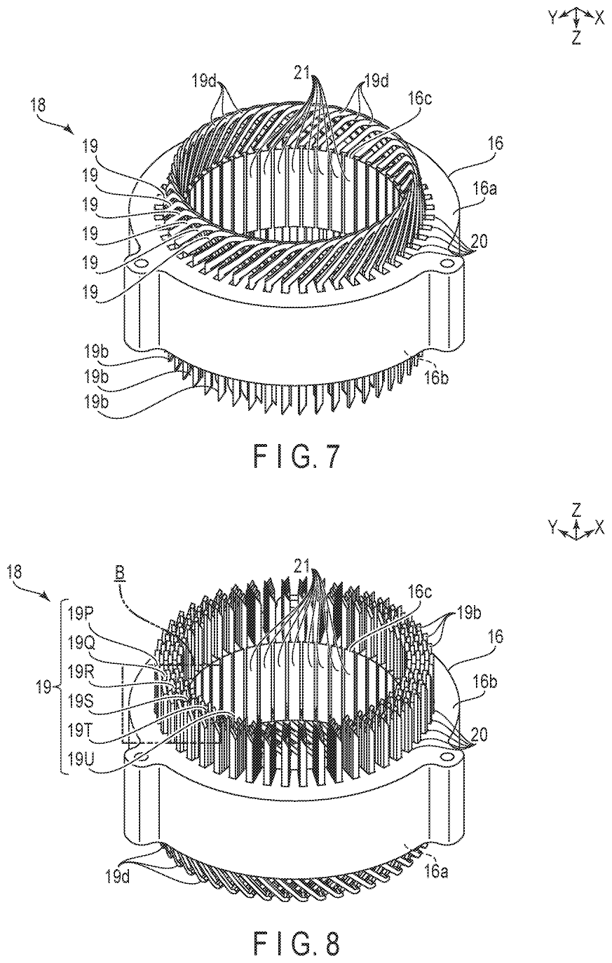

FIG. 7 is a perspective view illustrating a state where the coil segments 19 are attached to the stator core 16.

As in FIG. 7, each pair of coil segments 19 is inserted into the slot 20 from one end surface 16a side of the stator core 16. The linear part 19a of the coil segment 19 is inserted into the slot 20 and protrudes from the other end surface 16b of the stator core 16 by a predetermined length, forming an extension part 19b. 96 (48×2) linear parts 19a positioned at both ends of one set (48) coil segments 19 arranged in a cylindrical shape correspond to cylinders of two layers in the corresponding 48 clots 20, and are inserted into, for example, sixth (outermost layer) and fifth positions. Three sets (144, 48×3) of cylindrically arranged coil segments 19 are inserted into the corresponding 48 slots 20 from one end surface 16a side of the stator core 16. The linear parts 19a and the extension parts 19b of the three sets of coil segments 19 are arranged in a cylindrical shape, with six layers of concentric and different diameters. In each slot 20, the linear parts 19a are arranged in the radial direction from the sixth (outermost) layer to the first (innermost) layer.

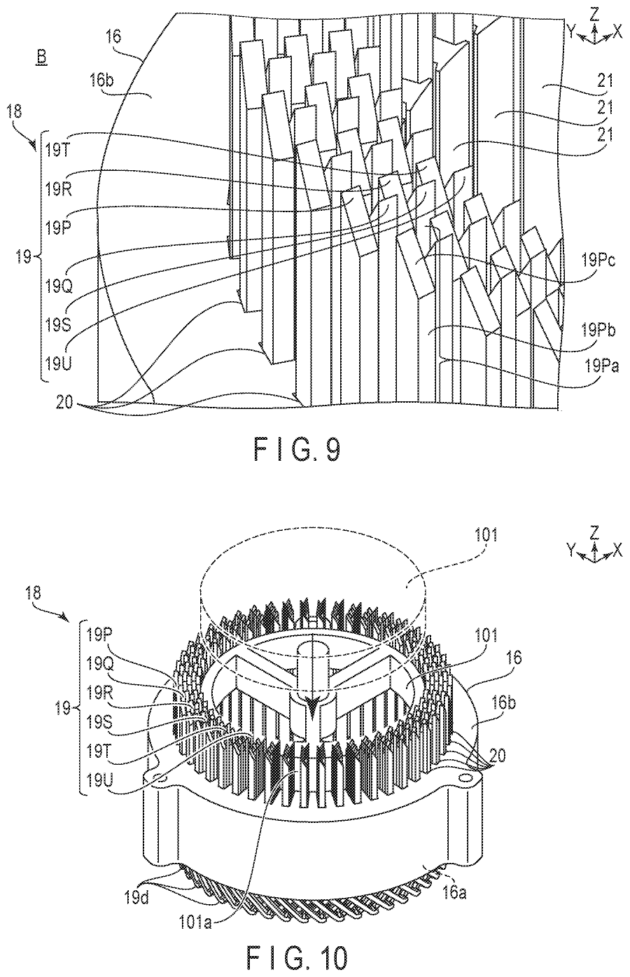

FIG. 8 is a perspective view illustrating all coil segments 19 attached to the stator core 16 while the vertical orientation is reversed, and FIG. 9 is a perspective view illustrating an area B of FIG. 8 in an enlarged manner.

As in FIGS. 8 and 9, the stator core 16 with the coil segments 19 is reversed as to the vertical orientation for the forming of extension parts 19b of the coil segment 19 by bending, which will be described later. Six linear parts 19a inserted into each slot 20 are aligned in the radial direction of the stator core 16. Hereinafter, in the radial direction, the coil segment, linear part, extension part, and inclined surface located in the outermost (sixth) layer will be referred to as 19P, 19Pa, 19Pb, and 19Pc; the coil segment, linear part, extension part, and inclined surface in the fifth layer will be 19Q, 19Qa, 19Qb, and 19Qc; the coil segment, linear part, extension part, and inclined surface in the fourth layer will be 19R, 19Ra, 19Rb, and 19Rc; the coil segment, linear part, extension part, and inclined surface in the third layer will be 19S, 19Sa, 19Sb, and 19Sc; the coil segment, linear part, extension part, and inclined surface in the second layer will be 19T, 19Ta, 19Ta, 19Tb, and 19Tc; and the coil segment, linear part, extension part, and inclined surface in the innermost (first) layer will be 19U, 19Ua, 19Ub, and 19Uc.

The inclination directions of the inclined surfaces aligned in the radial direction 19Pc, 19Qc, 19Rc, 19Sc, and 19Uc are alternately opposite. In other words, the inclined surfaces of the sixth, fourth, and second layers 19Pc, 19Rc, and 19Tc are inclined in the same direction, while the inclined surfaces of the fifth, third, and first layers 19Qc, 19Sc, and 19Uc are inclined in the opposite direction.

FIG. 10 is a perspective view illustrating a state where an inner wall jig 101 is attached to the inside of the stator core 16.

As in FIG. 10, the inner wall jig (second jig) 101 is placed inside the innermost extension part 19Ub, which is arranged in a cylindrical shape. The inner wall jig 101 is formed in a cylindrical shape and has an outer surface 101a that functions as a support surface. The inner wall jig 101 is formed of a metal with sufficient rigidity. The diameter of the inner wall jig 101 is formed to be substantially the same as the the inner diameter of the cylinder structured by the innermost extension part 19Ub. Note that, the inner wall jig 101 is not limited to a cylindrical shape, and may be formed in the shape of a solid cylinder.

The inner wall jig 101 is coaxial with the stator core 16, and inserted into the inside of the innermost extension part 19Ub. Thus, the outer surface 101a of the inner wall jig 101 is adjacent to and facing the inner peripheral side surface of the extension part 19Ub. When bending and forming the innermost extension part 19Ub in the circumferential direction of the stator core 16, the inner wall jig 101 supports the extension part 19Ub such that the extension part 19Ub does not tilt toward the radial inward direction of the stator core 16. Here, the extension part 19Ub located in the first layer (innermost layer) does not include other extension part 19b adjacent thereto in the inner radial direction of the stator core 16. That is, the extension part 19Ub located in the first layer (innermost layer) is supported from the inner radial direction by the inner wall jig 101, thereby preventing the extension part 19Ub from collapsing toward the inside in the radial direction.

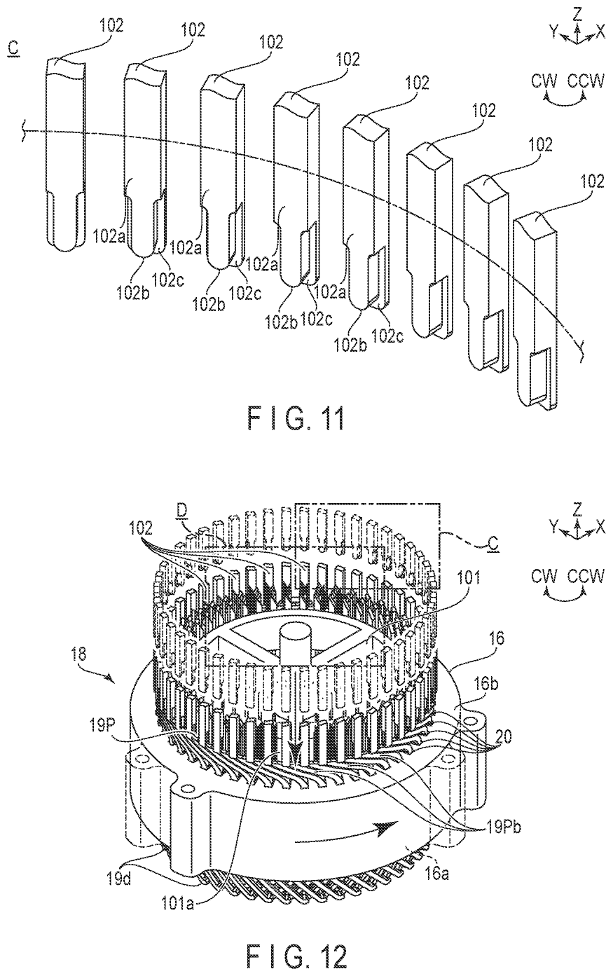

FIG. 11 is a perspective view of a forming jig 102 for forming the coil segments 19 by bending.

In FIG. 11, eight forming jigs 102 are shown as an example. As in FIG. 12 and the like described later, 48 forming jigs 102 are arranged as one set, which are arranged in a cylinder at the approximately regular intervals. One set of forming jigs 102 simultaneously press 48 extension parts 19b of one layer each form the coil segments 19 attached to the stator ison core 16 for forming by bending.

The forming jig (first jig) 102 includes a rectangular prism-shaped body 102a extending parallel to the central axis C1 of the stator core 16, that is, in the vertical direction, a pressor 102b extending downward from the body 102a with the lower end curved into an arc shape, and a flange 102c located radially outward from the stator core 16 than is the pressor 102b, which are formed integrally with a metal or the like. The flange 102c is larger in width and length than the pressor 102b, and protrudes outward from both edges and the bottom edge of the pressor 102b. In other words, the flange 102c is formed to cover the pressor 102b from the outside in the radial direction of the stator core 16 toward the inside. Specifically, the forming jig 102 partially cuts the both side edges and the lower edge of the lower end of the body 102a to form the part located inside the stator core 16 in the radial direction as a pressor 102b, and the part located outside the stator core 16 in the radial direction as a flange 102c. The body 102a is supported by a vertically-movable support, which is not shown.

Using the above mentioned pair of forming jigs 102, the extension part 19b of the coil segment 19 is bent layer by layer. In one example, the extension parts 19b are bent per layer from the outermost (sixth) layer to the innermost (first) layer by the forming jigs 102.

FIG. 12 is a perspective view illustrating a process of forming 48 extension parts 19Pb positioned in the sixth (outermost) layer by the forming jigs 102 by bending.

As in FIG. 12, the spacing between a set of forming jigs 102 is adjusted to be a diameter which substantially corresponds to the diameter of the cylinder formed by the outermost extension parts 19Pb. 48 forming jigs 102 are arranged to the positions aligned with 48 extension parts 19Pb, and the pressor 102 is placed in contact with the inclined surface (tip end surface) 19Pc of the extension part 19Pb, and the flange 102c is placed in contact with the outer peripheral side surface of the extension part 19Pb. In this state, the forming jig 102 is lowered in the axial direction to contact the extension part 19Pb via the inclined surface 19Pc, and also rotates the stator core 16 about the central axis in the direction of inclination of the inclined surface 19Pc, in this case counterclockwise CCW. This causes the outermost 48 extension parts 19Pb to bend, and the inclined surface 19Pc becomes approximately parallel to the other end surface 16b of the stator core 16.

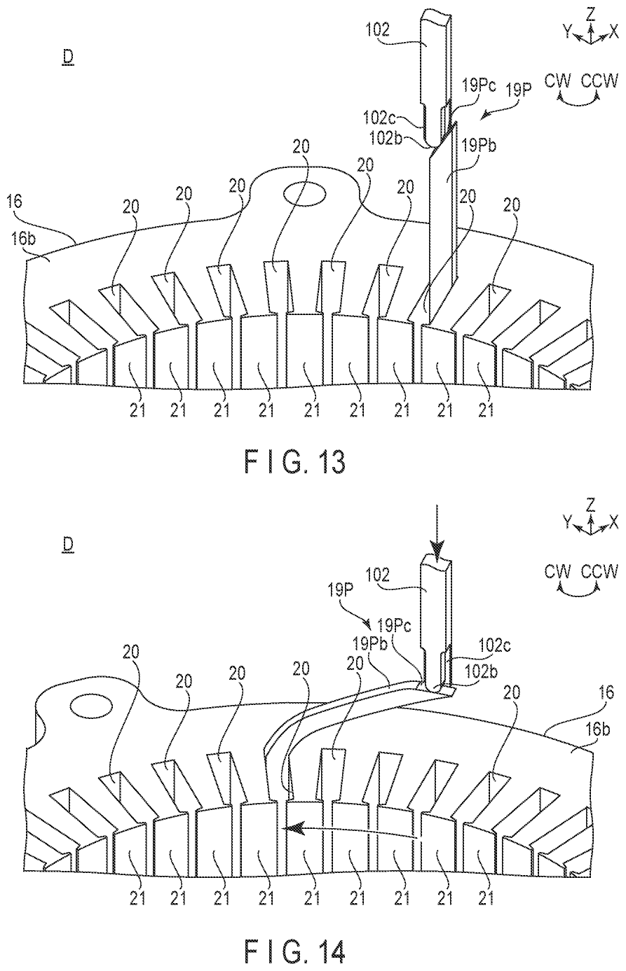

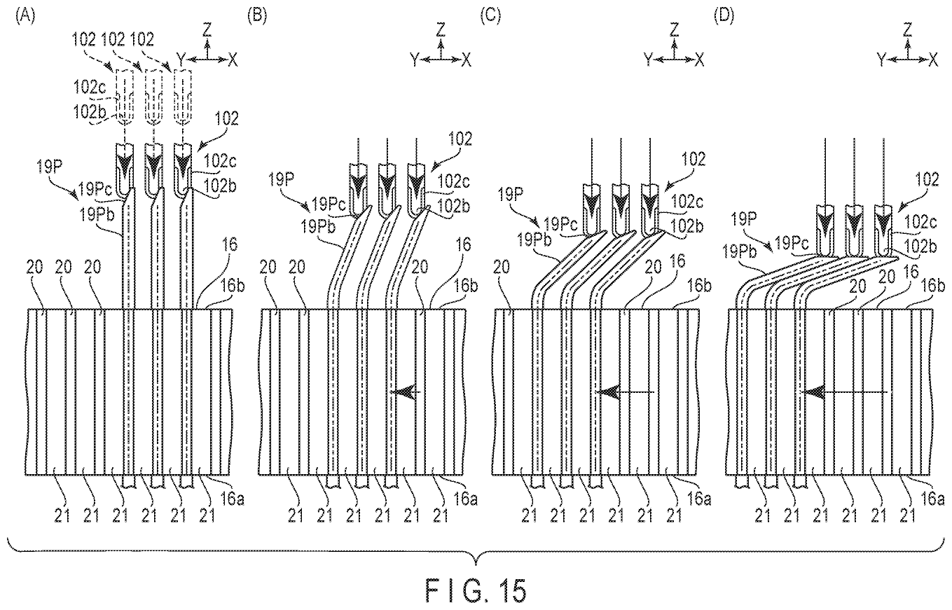

FIG. 13 is a perspective view illustrating a state of the coil segment 19P before bending, and FIG. 14 is a perspective view illustrating a state where the coil segment 19P after bending. FIG. 15 is a schematic side view of the bending process.

As in FIGS. 13 and 15(A), right before bending, the extension part 19Pb projects upward along the axial direction of the stator core 16 from the other end surface 16b of the stator core 16. The inclined surface 19Pc of the extension part 19Pb is inclined with respect to the central axis. The pressor 102b of the forming jig 102 is in contact with the inclined surface 19Pc, and the flange 102c supports the outer surface of the extension part 19Pb toward the radial inward direction of the stator core 16.

As in FIGS. 14 and 15(B), (C), and (D), the forming jig 102 is lowered, and the pressor 102b presses the inclined surface 19Pc along the axial direction of the stator core 16 toward the other end surface 16b side, while the stator core 16 is rotated counterclockwise CCW. This causes the extension part 19Pb is pressed down and bent in the direction opposite to the inclination direction of the inclined surface 19Pc and in the circumferential direction of the stator core 16. At that time, the inclined surface 19Pc descends toward the other end surface 16b of the stator core 16, but is not moved in the circumferential direction of the stator core 16. In other words, accordion to the bending process, the inclined surface 19Pc of the extension part 19Pb does not move in the circumferential direction of the stator core 16 while the base end part of the extension part 19Pb is bent in the circumferential direction of the stator core 16. As a result, the extension part 19Pb is bent to be inclined clockwise CW from the base end side to the tip end side. As in FIGS. 14 and 15(D), the extension part 19Pb is bent such that the inclined surface 19Pc is almost parallel to the other end surface 16b of the stator core 16.

During the bending and forming process, the flange 102c of the forming jig 102 contacts to the outer peripheral side surface of the extension part 19Pb to support the extension part 19Pb such that it does not fall to the outer radial direction of the stator core 16. In other words, the extension part 19Pb of the sixth (outermost) layer tends to incline radially outward if there is not a flange 102c of the forming jig 102 since there are no other adjacent extension parts 19b in the outer radial direction. On the other hand, the extension part 19Pb of the sixth (outermost) layer is prevented from inclining toward the inner radial direction by the extension part 19b of the fifth layer which is adjacent thereto in the inner radial direction of the stator core 16.

The pair of forming jigs 102 is raised to a position where it is separated from the coil segment 19 after the forming by bending. Next, a drive mechanism which is not shown is used to move the forming jigs 102 inward in the radial direction by one layer, and the distance between the forming jigs 102 is adjusted to be narrower such that the diameter of the placement of the molding jig 102 is aligned with the diameter of the fifth-layer extension part 19Qb. In this state, the molding jigs 102 are lowered to simultaneously press the inclined surfaces 19Qc of 48 extension parts 19Qb, while rotating the stator core 16 in the clockwise direction CW, in order to simultaneously bend the fifth extension part 19Qb along the circumferential direction of the stator core 16.

At each time when the forming by bending of the extension part 19b ends, the forming jigs 102 are moved to the inner radial direction of the stator core 16 by a distance equivalent to one layer of the coil segment 19, and the above-mentioned forming by bending process is repeated. After the forming by bending of the extension part 19b in the all layers (six layers in total from the outermost sixth layer to the innermost first layer) is completed, the forming jigs 102 are moved to the outer radial direction of the stator core 16 and return to the position corresponding to the outermost layer.

The extension parts 19Pb, 19Qb, 19Rb, 19Sb, 19Tb, and 19Ub are alternately bent in opposite directions along the circumference of the stator core 16. That is, the extension part 19Pb (sixth layer), 19Rb (fourth layer), and 19Tb (second layer) are bent along the circumferential direction of the stator core 16, in the clockwise direction CW from the base end side to the tip end side. Furthermore, the extension parts 19Qb (fifth layer), 19Sb (third layer) and 19Ub (first layer) are bent along the circumferential direction of the stator core 16, in the counterclockwise direction CCW from the base end side to the tip end side. The bending direction can be selected by changing the direction of inclination of the inclined surface 19c and the direction of rotation of the stator core 16.

When the pressor 102b of the forming jig 102 is used to press, for example, the inclined surface 19c of the fifth-layer extension part 19Ub for the forming by bending, the flange 102c of the forming jig 102 may contact to the sixth-layer extension part 19Ub which has been bent. In that case, the sixth-layer extension part 19b is elastically deformed by being pressed by the flange 102c; however, when, the jig 102 is separated therefrom, the extension part 19b returns to the original bent position due to springback.

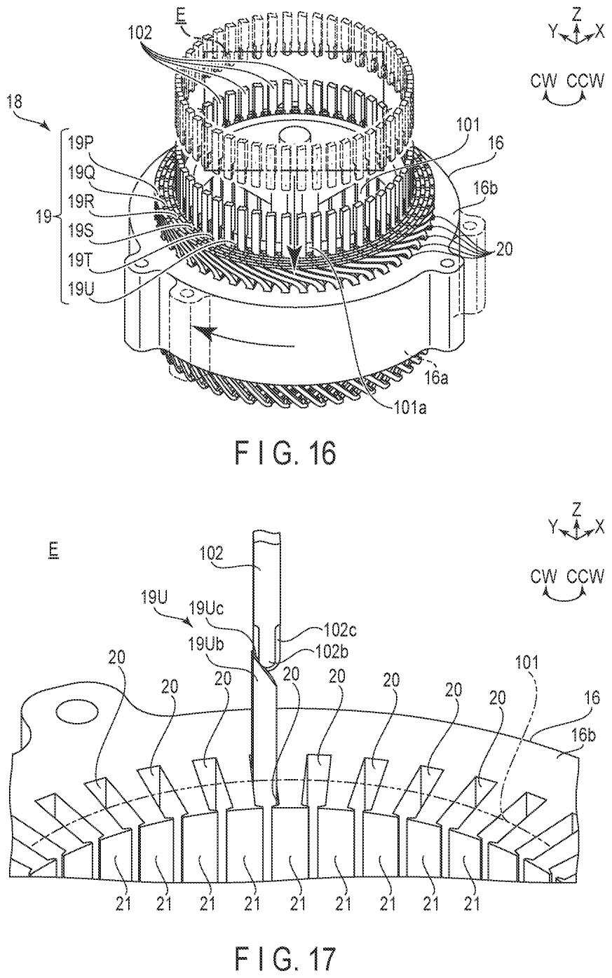

FIGS. 16, 17, 18, and 19 are perspective views illustrating the bending process of the innermost extension parts, respectively.

As in FIG. 16, one set of forming jigs 102 is moved to the narrowest distance from each other, and adjusted such that the diameter thereof is aligned with the diameter of the innermost extension part 19Ub. After the adjustment, the forming jig 102 is lowered in the direction of the central axis of the stator core 16, and the inclined surfaces Uc of the 48 extension parts 19Ub located in the innermost layer are pressed simultaneously.

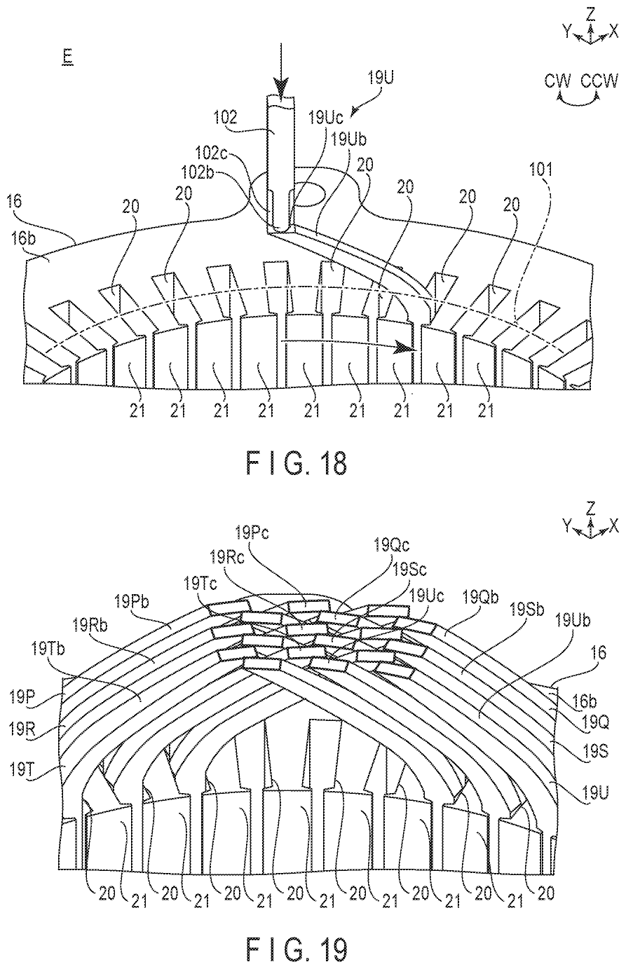

As in FIGS. 17 and 18, the pressor 102b of the forming jig 102 presses the inclined surface 19Uc of the extension part 19Ub downward. At the same time, the stator core 16 is rotated clockwise CW. This causes the base end part of the extension part 19Ub is bent in the opposite direction of the inclination direction of the inclined surface 19Uc and in the circumferential direction of the stator core 16. The extension part 19Ub is bent to the position where the inclined surface 19Uc becomes substantially parallel to the other end surface 16b of the stator ironc core 16.

During the forming by bending process, the flange 102c of the forming jig 102 supports the outer peripheral side surface of the extension part 19Ub to prevent the extension part 19Ub from moving in the outer radial direction and deforming. Furthermore, during the forming by bending, the inner peripheral side surface of the extension part 19Ub is supported by the outer peripheral surface 101a of the inner wall jig 10, and thus, the extension part 19Ub is prevented from moving in the outer radial direction and deforming. That is, the extension part 19Ub of the first layer (innermost layer) tends to be easily deformed in the inner radial direction according to the pressing process because there is not other extension parts 19b adjacent thereto in the inner radial direction of the stator core 16; however, with the outer peripheral surface 101a of the inner wall jig 101 pressing the extension part 19Ub, the extension part 19Ub can be prevented from deforming or collapsing in the inner radial direction.

After the forming by bending, a set of forming jigs 102 is raised above the inner wall jig 101, and becomes apart from the coil segment 19.

Whether or not the extension part 19Ub of the first (innermost) layer is inclined to the inner radial direction of the stator core 16 depends on the material of the coil segment 19 and bending conditions. Therefore, if the conditions are such that the extension part 19Ub of the first (innermost) layer is not easily deformed in the inner radial direction, or if the deformation is within the acceptable range, the inner wall jig 101 may be omitted.

FIG. 19 is a perspective view illustrating a part of the coil segment 19 formed by bending in an enlarged manner.

As in the figure, with the forming jig 102 being apart from the coil segment 19, the extension parts 19Pb, 19Qb, 19Rb, 19Sb, 19Tb, and 19Ub of the coil segment 19 are slightly misaligned in the inner radial direction of the stator core 16 due to springback after the forming by bending. The inclined surfaces 19Pc, 19Qc, 19Rc, 19Sc, 19Tc, and 19Uc are shifted from each other in the circumferential direction of the stator core 16, and are zigzagged in the radial direction of the stator core 16. There is a slight gap between the sixth layer inclined surface 19Pc and the fifth layer inclined surface 19Qc, between the fourth layer inclined surface 19Rc and the third layer inclined surface 19Sc, and between the second layer inclined surface 19Tc and first layer inclined surface 19Uc, respectively.

Therefore, by curving the extension part in the next bending process, the gap between the inclined surfaces is eliminated, and the inclined surfaces are arranged in a row in the radial direction.

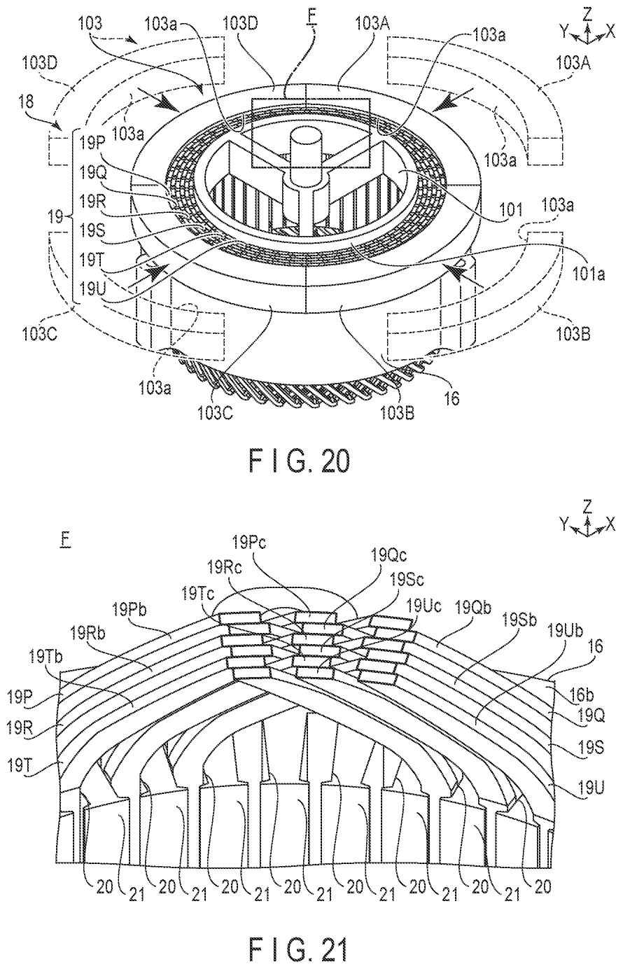

FIG. 20 is a perspective view illustrating a step of the bending process, and FIG. 21 is a perspective view illustrating a part of the extension part, inner wall jig, and outer wall jig in the bending process in an enlarged manner.

As in FIG. 20, in the bending process, the inner wall jig 101 and the outer wall jig 103 press the extension part 19b from both sides in the radial direction in order to perform the bending process of the extension part 19b. The outer wall jig 103 includes multiple ring-shaped members, for example, four arc-shaped dividing jigs 103A, 103B, 103C, and 103D divided into four. The outer wall jig 103 has an inner surface 103a functioning as an inclined surface. In a state where the ring-shaped outer wall jig 103 is structured with a combination of the dividing jigs 103A to 103D, the diameter of the inner peripheral surface 103a is slightly smaller than the outer diameter of the cylinder formed of 48 extension parts 19Pb located in the sixth (outermost) layer. The dividing jigs 103A to 103D are formed of a metal with sufficient rigidity.

As in FIGS. 20 and 21, in the bending process, four dividing jigs 103A, 103B, 103C, and 103D are moved from the outer radial direction to the inner wall jig 101 by the driving mechanism which is not shown, and the outermost extension part 19b is pressed against the inner wall jig 101 by the inner peripheral, surface 103a of the outer wall jig 103 at a predetermined pressure. Six layers of the extension parts 19Pb, 19Qb, 19Rb, 19Sb, 19Tb, and 19Ub interposed between the inner peripheral surface 103a of the outer wall jig 103 and the outer peripheral surface 101a of the inner wall jig 101 to be pressed by the outer wall jig 103 and the inner wall jig 101 from both sides in the radial direction. Therefore, at least, the tip end parts of the six-layer extension parts 19Pb, 19Qb, 19Rb, 19Sb, 19Tb, and 19Ub are bent along the the inner peripheral surface 103a of the outer wall jig 103 and the outer peripheral surface 101a of the inner wall jig 101.

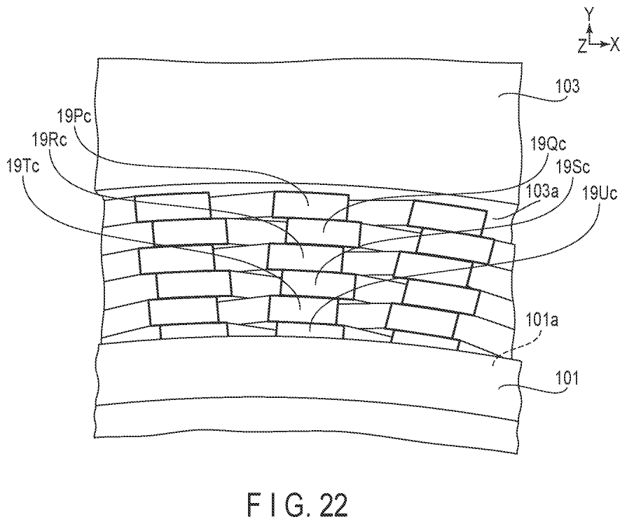

FIG. 22 is a perspective view illustrating the extension part 19b after being subjected to the bending process. As illustrated in the figure, the bending process allows the extension parts 19Pb, 19Qb, 19Rb, 19Sb, and 19Tb of the coil segment 19 to be free from being misaligned in the outer radial direction and gaps therebetween, and the inclined surfaces 19Pc, 19Qc, 19Rc, 19Sc, 19Tc, and 19Uc are adjacent to each other and lined up substantially in a row in the radial direction of the stator core 16. This allows the gap between the sixth-layer inclined surface 19Pc and the fifth-layer inclined surfaces 19Qc, the gap between the fourth-layer inclined surface 19Pc and the third-layer inclined surface 19Sc, and the gap between the second-layer inclined surface 19Tc and the first-layer inclined surface 19Uc basically disappear, which facilitates joining thereof, respectively.

In the aforementioned forming by bending, whether or not a gap is generated between adjacent inclined surfaces 19c in the radial direction of the stator core 16 depends on the material for the coil segment 19 and bending conditions. Depending on the conditions, there may be no gap between adjacent inclined surfaces 19c in the radial direction of the stator core 16. If no gap occurs between adjacent inclined surfaces 19c or if the gap is within the acceptable range, the bending process shown in FIG. 20 may be omitted.

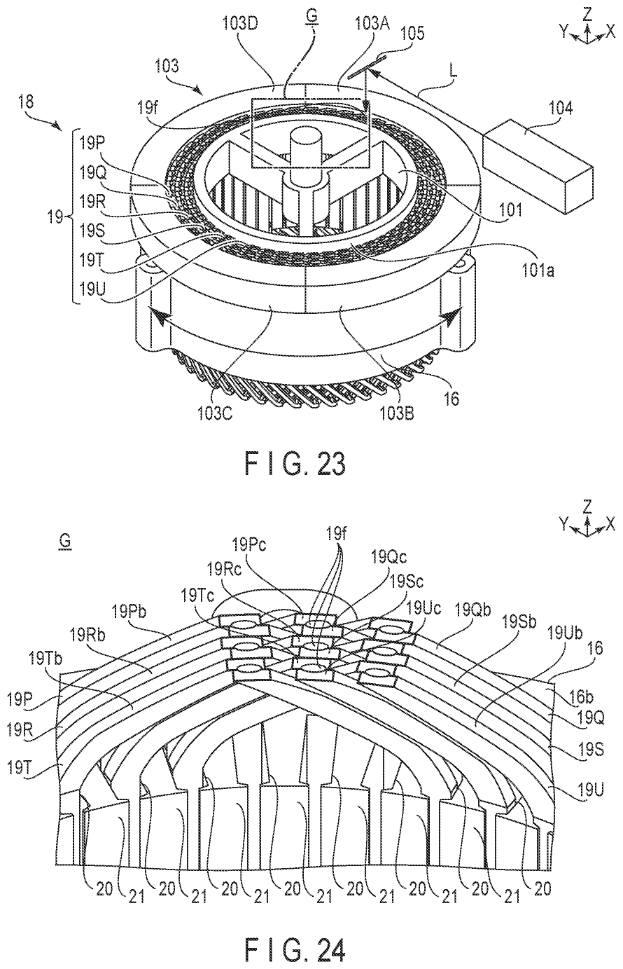

After the bending process described above, the two adjacent inclined surfaces (planes) 19c in the radial direction are mechanically and electrically joined to each other to form a three-phase coil 18. FIG. 23 is a perspective view illustrating an example of the joining process, and and FIG. 24 is a perspective view illustrating the joined joint.

According to the present embodiment, as an example, the joining process joins the inclined surfaces by welding with a laser beam. As in FIG. 23, while the six-layer extension part 19b formed by the forming by bending is interposed between the inner wall jig 101 and the outer wall jig 103, laser beam L is emitted from the laser light source 104 such that the laser beam L is irradiated onto the inclined surface 19c of the extension part 19b via a galvanometer mirror 105. Specifically, the galvanometer mirror 105 is driven while the stator core 16 is held in a predetermined position, and the laser beam, is irradiated onto each of the boundary part of the sixth-layer inclined surface 19Pc and the fifth-layer inclined surface 19Qc aligned in the radial direction, the boundary part of fourth-layer inclined surface 19Rc and the third-layer inclined surface 19Sc, and the boundary part of the second-layer inclined surface 19Tc and the first-layer inclined surface 19Uc. The two adjacent inclined surfaces 19C are each partially heated and melted by the laser beam L, and then fused together and solidified into a weld bead 19f (see FIG. 24). The weld bead 19f mechanically and electrically bonds the two adjacent inclined surfaces 19c.

After the welding of a row of inclined surfaces 19c, the stator core 16 is rotated circumferentially by 7.5 degrees (360 degrees divided by 48) and then stopped. In this state, the laser beam L is irradiated onto the boundary part, between the inclined surfaces 19Pc and 19Qc, the boundary part between the inclined surfaces 19Rc and 19Sc, and the boundary part between the inclined surfaces 19Tc and 19Uc in the second row via the galvanometer mirror 105 to weld the two adjacent inclined surfaces. This welding process is repeated to weld all rows of inclined surfaces in the radial direction, two by two. As in FIG. 24, by welding and joining the inclined surfaces 19c of each row two by two, the three-phase (U-phase, V-phase, and W-phase) coil 18 including a plurality of coil segments 19 is formed.

In the joining process, laser welding may be performed by propagating the laser beam, derived from the semiconductor laser by means of an optical fiber, and focusing the laser beam derived from the optical fiber onto the inclined surfaces 19c by means of a focusing lens. In this case, the focusing lens connected to the optical fiber is moved near the inclined surfaces 19c of the coil segment 19 by a linear stage or robot hand. The joining process is not limited to laser welding, and other joining methods such as soldering or ultrasonic joining may be used.

After the joining process is completed, the inner wall jig 101 and the outer wall jig 103 are removed from the stator core 16 and the coil segment 19. Then, the tips of the extension part 19b and the joints are then covered with powder coating or an insulating material such as varnish, which is used to protect the electrical insulation. Furthermore, to each phase of coil 18, a U-phase connection terminal TU, a V-phase connection terminal TV and a W-phase connection terminal TW are connected.

Through the above manufacturing process, the coil 18 is attached and connected to the stator core 16 to form the stator 12.

According to the manufacturing method of the stator of the present embodiment structured as above, in each of a plurality of coil segments 19, a pair of linear parts 19a are each inserted into each of a slot 20 from one end surface 16a side of the stator core 16 such that extension parts 19b including a linear part and an inclined surface project from the other end surface 16b side of the stator core 16, and multiple linear parts 19a become adjacent to each other in the radial direction in each slot 20, and therefore, the coil segments 19 are arranged in a multi-layered cylindrical shape coaxial with the stator core 16. The extension part 19b of the coil segment 19 is supported from the inner radial direction of the stator ironc core 16 by a flange 102c of a forming jig 102, and the inclined surface 19c is pressed by a pressor 102b of the forming jig 102 toward the other end surface 16b in the axial direction of the stator core 16, while rotating the stator core 16 in the circumferential direction in order to bend the extension part 19b in the circumferential direction of the stator core 16 to place the inclined surface 19c of the coil segment 19 to be substantially parallel to the other end surface 16b. After the forming by bending, the inclined surfaces 19c adjacent to each other in the radial direction of the stator core 16 are bonded together to form the coil 18. Furthermore, a plurality of extension parts 19b of the coil segments 19 arranged in a multi-layered cylindrical shape are bent, in the radial direction of the stator 12, simultaneously per layer from the outermost extension part to the innermost extension part. At that time, the extension parts 19b arranged in a cylindrical shape are bent along the inner other extension parts 19b arranged in a cylindrical shape. Furthermore, when the innermost extension parts 19b are bent, the extension parts 19b are supported from the inner peripheral side by the outer peripheral surface 101a of the inner wall jig 101, to prevent them from bending in the inner radial direction and collapsing.

According to the manufacturing method, it is possible to bend the extension parts without gripping the tips of the extension parts. Therefore, there is no need to provide a gripping portion in the extension part of the coil segment, and the extension part can be set shorter by the extent of the gripping portion. Therefore, the protrusion height of the coil end 18b of the formed coil (protrusion height from the other end surface 16b of the stator core 16) can be kept low. As a result, the coil 18 and the stator 12 can be made smaller.

According to the manufacturing method of the present embodiment, during the forming of the extension part 19b by bending with the forming jig 102, the flange 102c of the forming jig 102 supports the extension part 19b from the outside of the stator core 16 in the radial direction, such that the extension part 19b is prevented from collapsing in the outer radial direction. Furthermore, during the forming of the innermost extension part by bending, the inner wall jig 101 supports the extension part 19b from the inner peripheral side, and thus, can prevent the extension part 19b from bending and collapsing in the inner radial direction of the stator core 16. This prevents misalignment of the inclined surface 19c of the extension part 19b, and allows the multiple inclined surfaces to be arranged without gaps in the radial direction. As a result, the inclined surfaces adjacent in the radial direction can be joined properly and easily.

As can be understood from the above, according to the present embodiment, a manufacturing method of a stator which can miniaturize the stator while a plurality of coil segments are properly bonded can be achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the number of coil turns and the number of coil segments installed are not limited to the above mentioned embodiment, but can be increased or decreased as needed. For example, four or eight segment linear parts may be placed in one slot. The dimensions, material, shape, etc., of the rotor are not limited to the above-mentioned embodiment, but can be changed in various ways according to the design. The rotor and rotary electric machine for the present embodiment are not limited to permanent magnet, field motors, but can also be applied to induction motors.

What is claimed is:

1. A method of manufacturing a stator, comprising:
preparing a plurality of coil segments which are rectangular conductors each including a pair of linear parts having an inclined surface inclined with respect to a length direction as each end thereof and other ends of the pair of linear part are connected to each other;
inserting the pair of linear parts of each of the coil segments from one end surface side of a stator core into each of slots such that an extension part formed of the linear part and the inclined surface projects from the other end surface side of the stator core, and placing multiple linear parts in each slot to be adjacent to each other in a radial direction, in order to arrange the coil segments in a multilayered cylindrical shape coaxial with the stator core;
while supporting an end of the extension part by a flange of a first jig from the radially outside of the stator core and pressing the inclined surface toward the other end surface of the stator core in an axial direction of the stator core by a pressing part of the first jig, rotating the stator core in a circumferential direction relative to the first jig, in order to bend the extension part in the circumferential direction of the stator core such that the inclined surface is positioned to be substantially parallel to the other end surface; and
joining the inclined surfaces adjacent to each other in the radial direction of the stator core.

2. The method of manufacturing a stator of claim 1, wherein the extension parts in one layer of the coil segments arranged in a cylindrical shape are simultaneously bent by a plurality of the pressing parts arranged in a cylindrical shape.

3. The method of manufacturing a stator of claim 2, wherein the extension parts arranged in a cylindrical shape and a multilayered manner are simultaneously bent every layers from the outermost layer to the innermost layer, in the radial direction of the stator.

4. The method of manufacturing a stator of claim 3, wherein, when bending the extension parts in the innermost layer, the extension parts are supported by a second jig from the inner radial direction.

5. The method of manufacturing a stator of claim 1, wherein the bent extension parts positioned outermost in the radial direction of the stator core are pressed from the radially outside to the inner radial direction of the stator core.

6. The method of manufacturing a stator of claim 1, wherein the bent extension parts arranged in the radial direction of the stator core are pressed from the radially outer side and the radially inner side of the stator core to be curved.

7. The method of manufacturing a stator of claim 1, wherein two surfaces of the bent extension parts adjacent to each other in the radial direction are welded to each other.
